(19) United States
(12) Patent Application Publication
(10) Pub. No.: US 2007/0053149 A1
(43) Pub. Date: Mar. 8, 2007

(54) MOUNTING APPARATUS FOR STORAGE DEVICE

(76) Inventors: Qin Guo, Shenzhen (CN); Guang-Yao Lee, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,625

(22) Filed: Jan. 4, 2006

(30) Foreign Application Priority Data
Sep. 2, 2005 (CN) 200520064116.8

(51) Int. Cl. G06F 1/16

(52) U.S. Cl. 361/685

(57) ABSTRACT

A mounting apparatus for holding a storage device includes a bracket and a fastener. The bracket includes a first sidewall, a second sidewall, and an entrance. The first sidewall and the second sidewall are parallel to each other. The first sidewall and the second sidewall corporately define a receiving space therebetween, and the storage device is received in the receiving space. The fastener includes a main portion, an installing portion, and a securing portion. The installing portion and the securing portion extends from two opposite ends of the main portion respectively. The installing portion is pivotally attached to the first sidewall of the bracket. The securing portion engages with the second sidewall of the bracket. The main portion blocks the entrance of the bracket. Thus, the storage device is secured in the bracket.

### FIELD OF THE INVENTION

The present invention relates to a mounting apparatus, and more particularly to a mounting apparatus for holding a storage device.

### DESCRIPTION OF RELATED ART

An electronic apparatus, such as a typical desktop computer, a tower computer, a server, and the like, usually includes storage devices, such as hard disk drives, compact disk read-only memory (CD-ROM) drives, digital video disc (DVD) drives, floppy disk drives, and the like. These devices are typically added to increase the functionality of the electronic apparatus as desired by a user. However, the installation of such devices in the electronic apparatus is always labor-intensive.

The installation of a hard disk drive in a computer typically involves use of screws to attach the hard disk drive to a bracket of a computer chassis. Usually, these screws are small enough to make them difficult to be manipulated and installed. It is laborious and time-consuming to manually manipulate the screws. Additionally, because of their small size, the screws are easier to be dropped by an assembler into the computer. Some accidental damage will occur in the computer due to impact of these moving parts, and the like causes.

To address the aforementioned problems, a plurality of mounting apparatuses is invented to reduce the number of needed screws. For example, a pair of detachable rails is attached to opposite sides of a storage device with screws. The storage device slides into and is secured to a drive bracket. However, the screws have to be removed to detach the rails from the storage device before replacing the storage device.

What is desired, therefore, is a mounting apparatus which conveniently and securely holds a storage device in a bracket.

### SUMMARY OF INVENTION

In one preferred embodiment, a mounting apparatus for holding a storage device comprises a bracket and a fastener. The bracket includes a first sidewall, a second sidewall, and an entrance. The first sidewall and the second sidewall are parallel to each other. The first sidewall and the second sidewall corporately define a receiving space therebetween, and the storage device is received in the receiving space. The fastener includes a main portion, an installing portion, and a securing portion. The installing portion and the securing portion respectively extends from two opposite ends of the main portion. The installing portion is pivotally attached to the first sidewall of the bracket. The securing portion engages with the second sidewall of the bracket. The main portion blocks the entrance of the bracket. Thus, the storage device is secured in the bracket.

Other advantages and novel features will become more apparent from the following detailed description of preferred embodiments when taken in conjunction with the accompanying drawings, in which:

### BRIEF DESCRIPTION OF DRAWINGS

FIG. 1 is an exploded, isometric view of a mounting apparatus in accordance with a preferred embodiment of the present invention, with a storage device;

FIG. 2 is an isometric view of a bracket of the mounting apparatus of FIG. 1;

FIGS. 3 and 4 are isometric views of a fastener of FIG. 1, respectively viewed from opposite aspects;

FIG. 5 is an assembled view of FIG. 1;

FIG. 6 is an isometric view of a fastener of a mounting apparatus, in accordance with another preferred embodiment of the present invention; and

FIG. 7 is an assembled view of the mounting apparatus of FIG. 6 and a storage device.

### DETAILED DESCRIPTION

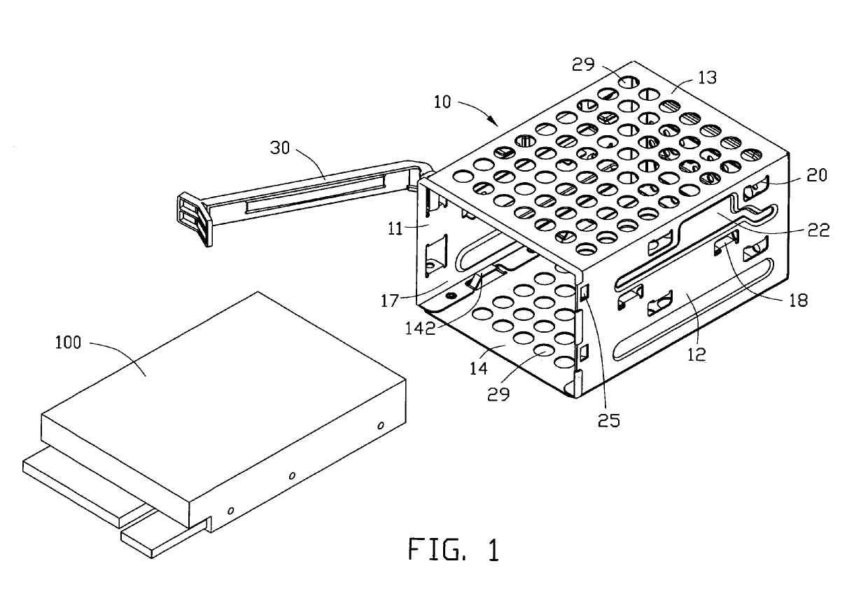

Referring to FIG. 1, in a preferred embodiment of the invention, a mounting apparatus is provided for holding a storage device 100. The mounting apparatus includes a bracket 10 and a fastener 30.

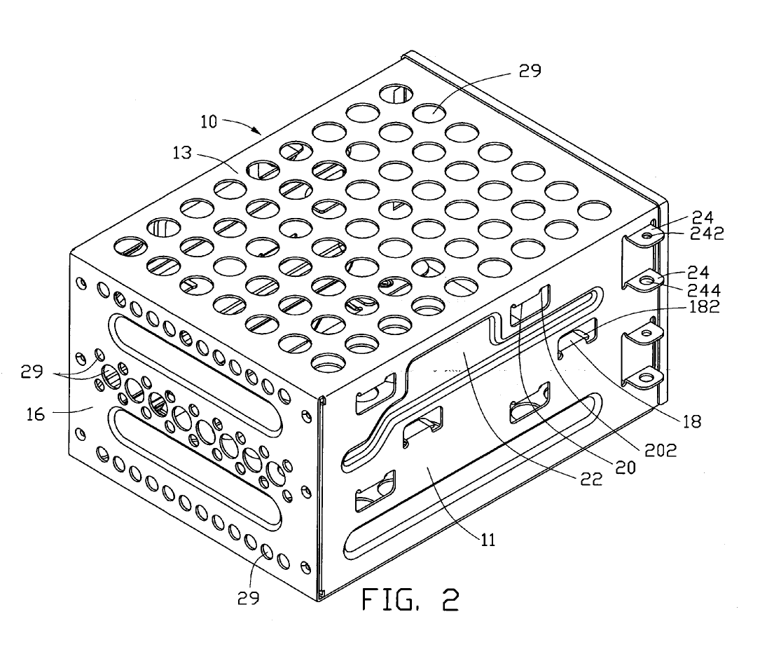

Referring also to FIG. 2, the bracket 10 includes a first sidewall 11, a second sidewall 12, a top wall 13, and a bottom wall 14. The first sidewall 11 and the second sidewall 12 are parallel to each other and perpendicular to the top wall 13 and the bottom wall 14. The top wall 13 connects top portions of the first sidewall 11 and the second sidewall 12, and the bottom wall 14 connects bottom portions of the first sidewall 11and the second sidewall 12. The bracket 10 also includes a third sidewall 16 and an entrance 17. The third sidewall 16 connects side portions of the first sidewall 11 and the second sidewall 12. The entrance 17 is defined in one side of the bracket 10. A plurality of supporting tabs 18 inwardly extends from the first sidewall 11 and the second sidewall 12. Another supporting tab 142 is disposed on the bottom wall 14. A plurality of stopping tabs 20 inwardly extends from the first sidewall 11 and the second sidewall 12. The stopping tabs 20 are located over the supporting tabs 18. The supporting tabs 18, 142 and the stopping tabs 20 define a receiving space for the storage device 100. Each end of the supporting tabs 18 is downward sloped as a guiding slope 182. Each end of the stopping tabs 20 is upward sloped as a guiding slope 202. The guiding slop 182 and the guiding slop 202 are near to the entrance 17. A baffle 22 inwardly extrudes from the first sidewall 11 and the second sidewall 12. The baffle 22 is located between the supporting tabs 18 and the stopping tabs 20. The guiding slop 182 and 202 are for guiding the storage device 100 into the bracket 10. The supporting tabs 18 and 142 are for supporting the storage device 100 and the stopping tabs 20 are for fixing the storage device 100 in a vertical direction. The baffle 22 is for fixing the storage device 100 in a horizontal direction.

A pair of installing plates 24 outwardly extends from the first sidewall 11. The installing plates 24 are in vicinity of the entrance 17 of the bracket 11. A first pivoting hole 242 and a second pivoting hole 244 are respectively defined in the installing plates 24. An inserting hole 25 is defined in the second sidewall 12. A plurality of heat dissipation holes 29 is defined in the top wall 13, the bottom wall 14, and the third sidewall 16 of the bracket 10. The heat dissipation holes 29 are for improving a heat dissipation for the storage device 100.

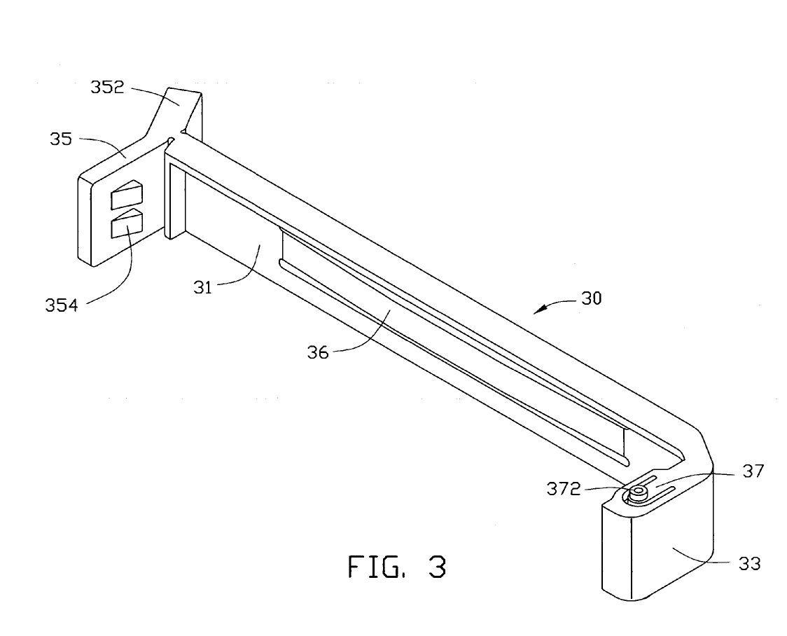

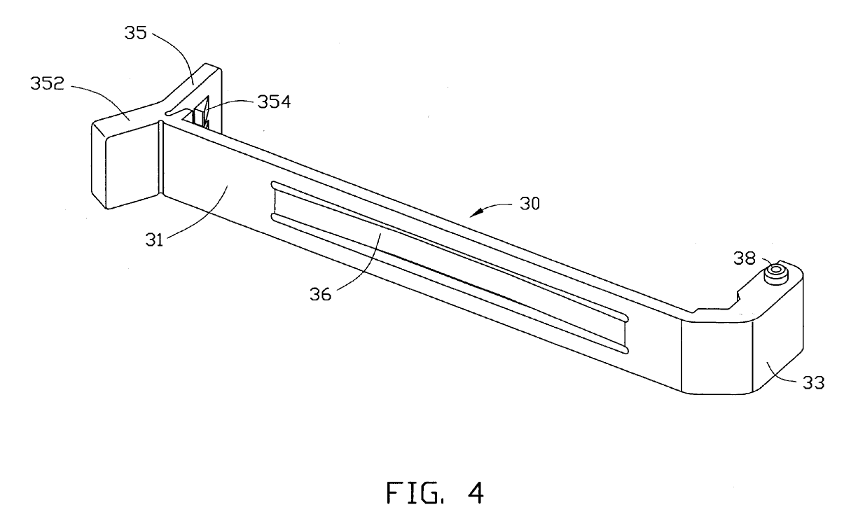

Referring to FIGS. 3 and 4, the fastener 30 has a “J” shape. The fastener 30 includes a main portion 31, an installing portion 33, and a securing portion 35. The installing portion 33 and the securing portion 35 perpendicularly extend from two opposite ends of the main portion 31 respectively in a direction, which is close to the entrance 17. A spring portion 36 is defined in a middle part of the main portion 31 and is tend to twist under a pressure. The installing portion 33 is hollow and has a ligulate portion 37 in a top thereof. A first pivoting pole 372 extrudes from the ligulate portion 37, corresponding to the first pivoting hole 242. A second pivoting pole 38 extrudes from a bottom portion of the installing portion 33, corresponding to the second pivoting hole 244. A handle 352 extends from the securing portion 35 toward an opposite direction of the securing portion 35. A pair of blocks 354 extrudes from the securing portion 35 toward the bracket 10.

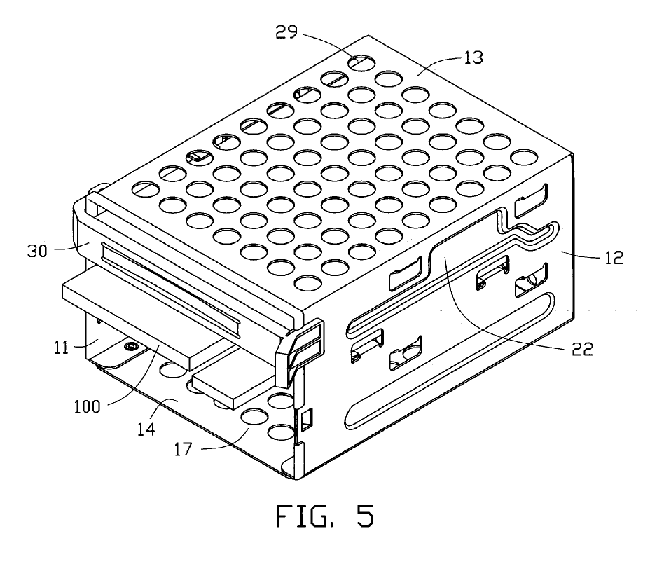

Referring also FIG. 1 to FIG. 5, in assembly, the fastener 30 is pivotally attached to the first sidewall 11 of the bracket 10, with the first pivoting pole 372 and the second pivoting pole 38 rotatably received in the first pivoting hole 242 and the second pivoting hole 244 of the bracket 10 respectively. The storage device 100 is put into the bracket 10 sliding along the supporting tabs 18 and the stopping tables 20 until the storage device 100 is blocked by the third sidewall 16. Then rotating the fastener 30 toward the entrance 17 of the bracket 10 until the securing portion 35 touches the second sidewall 12. The handle 352 is outwardly moved, and then the blocks 354 are inserted into the inserting holes 25. The main portion 31 of the fastener 30 covers the entrance 17 and blocks a rear of the storage device 100. Thus, the storage device 100 is secured in the bracket 10.

To detach the storage device 100 from the bracket 20, the handle 352 is moved toward the second sidewall 12, then the blocks 354 are moved out of the inserting holes 25, and the fastener 35 is rotated far away from the entrance 17 of the bracket 10. Thus, the storage device 100 is easily taken out from the bracket 10.

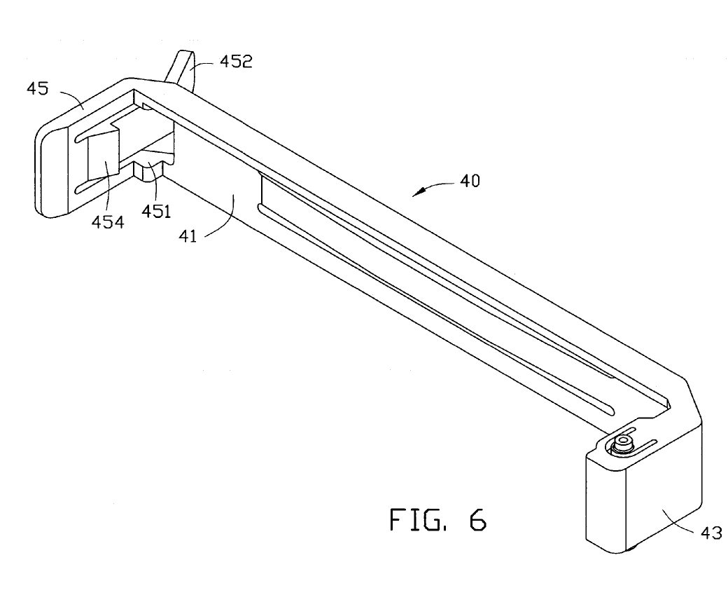

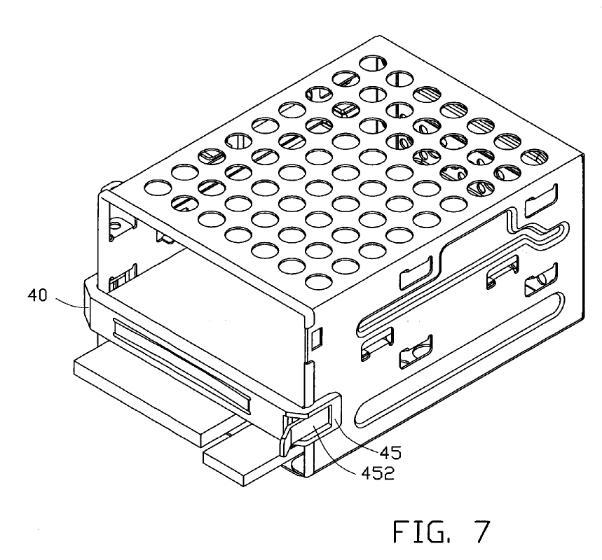

Referring to the FIGS. 6 and 7, a mounting apparatus in accordance with another preferred embodiment of the present invention is shown. A fastener 40 includes a main portion 41, an installing portion 43, and a securing portion 45. The installing portion 43 and the securing portion 45 respectively extend from two ends of the main portion 41. A slot 451 is defined in a middle of the securing portion 45. A handle 452 extends from one side of the slot 3451 outward to an opposite direction of the securing portion 45. A pair of blocks 454 extrudes from the handle 452 corresponding to the inserting hole 25 of the second sidewall 12.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment.

What is claimed is:

1. A mounting apparatus for holding a storage device, the mounting apparatus comprising:
a bracket comprising a first sidewall, a second sidewall and an entrance, the second sidewall being parallel to the first sidewall and defining an inserting hole therein, the first sidewall and the second sidewall corporately defining a receiving space therebetween, the storage device being put into the bracket from the entrance and engaged in the receiving space; and
a fastener comprising a main portion, an installing portion and a securing portion, the installing portion and the securing portion extending from two opposite ends of the main portion respectively, the installing portion pivotally attached to the first sidewall of the bracket, the securing portion comprising a block extruding therefrom and the block being latched in the inserting hole of the bracket, the main portion covering the entrance of the bracket.

2. The mounting apparatus as claimed in claim 1, wherein the bracket further comprises a third sidewall connecting side portions of the first sidewall and the second sidewall, a top wall connecting top portions of the first sidewall and the second sidewall, and a bottom wall connecting bottom portions of the first sidewall and the second sidewall.

3. The mounting apparatus as claimed in claim 1, wherein a plurality of supporting tabs and stopping tabs inwardly extend from the first sidewall and the second sidewall, the stopping tabs locating over the supporting tabs.

4. The mounting apparatus as claimed in claim 3, wherein each of the supporting tabs and the stopping tables comprises a guiding slope extending therefrom, the guiding slop closing to the entrance.

5. The mounting apparatus as claimed in claim 4, wherein an installing plate outwardly extends from the first sidewall, the installing portion pivotally attached to the installing plate.

6. The mounting apparatus as claimed in claim 5, wherein the installing plate defines a pivoting hole, and the fastener comprises a pivoting pole, the pivoting pole received in the pivoting hole.

7. The mounting apparatus as claimed in claim 1, wherein a handle extends from the securing portion in a direction opposite to a direction in which the securing portion extends.

8. The mounting apparatus as claimed in claim 1, wherein the securing portion defines a slot in a middle thereof, and a handle extends from one side of the slot in a direction opposite to a direction in which the securing portion extends.

9. A mounting apparatus assembly comprising:
a storage device;
a bracket containing the storage device therein and comprising a first sidewall, a second sidewall parallel to the first sidewall, the first sidewall and the second sidewall comprising a plurality of supporting tabs and stopping tabs, for the storage device being sandwiched therebetween; and
a fastener pivotally attached to the bracket, the fastener comprising a main portion blocking the storage device, and a securing portion for engaging with the bracket.

10. The mounting apparatus assembly as claimed in claim 9, wherein the bracket further comprises a third sidewall connecting side portions of the first sidewall and the second sidewall, a top wall connecting top portions of the first sidewall and the second sidewall, a bottom wall connecting bottom portions of the first sidewall and the second sidewall, and an entrance thereof.

11. The mounting apparatus assembly as claimed in claim 10, wherein each of the supporting tabs and the stopping tables comprises a guiding slope extending therefrom, the guiding slop closing to the entrance.

12. The mounting apparatus assembly as claimed in claim 9, wherein the fastener further comprises an installing portion extending therefrom, the installing portion pivotally attached to an installing plate extending from the first sidewall.

13. The mounting apparatus assembly as claimed in claim 12, wherein the installing plate defines a pivoting hole, and the fastener comprises a pivoting pole, the pivoting hole being received in the pivoting hole.

14. The mounting apparatus assembly as claimed in claim 9, wherein the second sidewall defines an inserting hole therein, and the securing portion of the fastener comprises a block, the block being latched in the inserting hole.

15. The mounting apparatus as claimed in claim 9, wherein a handle extends from the securing portion in a direction opposite to a direction in which the securing portion extends.

16. The mounting apparatus as claimed in claim 9, wherein the securing portion defines a slot in a middle thereof, and a handle extends from one side of the slot in a direction opposite to a direction in which the securing portion extends.
